(19) United States
(12) Patent Application Publication
(10) Pub. No.: US 2018/0368366 A1
(43) Pub. Date: Dec. 27, 2018

(54) HAND WEARABLE CONTROL APPARATUS

(71) Applicant: E-Collar Technologies, Inc., Garrett, IN (US)

(72) Inventors: Greg Van Curen, Fremont, IN (US); Ho-Sung So, Seoul (KR); Bong-Ki Min, Gyeonggi-do (KR)

(73) Assignee: E-Collar Technologies, Inc., Garrett, IN (US)

(21) Appl. No.: 15/954,689

(22) Filed: Apr. 17, 2018

(30) Foreign Application Priority Data
Jun. 23, 2017 (KR) 10-2017-0079436

(51) Int. Cl. A01K 15/02; G06F 1/16

(52) U.S. Cl. CPC A01K 15/021; A01K 15/022; G06F 1/163

(57) ABSTRACT

A control apparatus worn on a hand to wirelessly control a device positioned at a remote place according to an embodiment includes a finger holding portion having a hole through which a finger passes, and at least one button mounted in a region of the two side surfaces of the hole at which the finger touches, a back of hand mount portion which extends from the finger holding portion, and is worn on the back of a user's hand, the back of hand mount portion in which an electronic device electrically connected to the at least one button is mounted, and a wrist wrap portion which extends from the back of hand mount portion, and fixes around the user's wrist.

### FIELD OF THE INVENTION

The present disclosure relates to a control apparatus for wirelessly controlling a device positioned at a remote place, and more particularly, to a control apparatus worn on a hand to wirelessly control a device positioned at a remote place.

### BACKGROUND ART

With the technology development of electronic devices including smartphones and tablet PCs, attempts have been made to control devices positioned at a remote place in a wireless manner using electronic devices. Typically, smartphones can be used to control TV, such as, changing the channel or volume, by incorporating the function of a remote controller to control the TV into the smartphones. These electronic devices are of portable type allowing users to put them in pockets or hold in their hands. However, when users wear casual clothes for walking and exercise, it is inconvenient in carrying with and there is a risk of the smartphones being stolen or lost. Accordingly, watch-type electronic devices that are worn on the wrist or arm are offered. The electronic devices for controlling devices positioned at a remote place in a wireless manner are also used in the field of animal training.

In the field of animal training, owners or trainers (hereinafter referred to as ‘users’) have employed various electric and electronic technologies in correcting animal's behavior since the late 1960s. For example, Patent Literature 1 (U.S. Pat. No. 6,131,535) discloses an animal training system including a collar type animal training receiver, and a hand-held animal training transmitter possessed by a user that makes high-frequency wireless communication with the collar type animal training receiver, in which the user takes control to deliver stimulation such as electrical stimulation to the collar type animal training receiver through the animal training transmitter, for example, when a dog does a behavior needed to correct, such as, barking, going beyond a preset boundary or attacking a human.

Using such electronic animal training systems, animals (typically dogs, but animals may be other pets such as cats or livestocks) are trained to do good behaviors. Also, these electronic animal training systems have advanced by employing electronic and communication technologies that are developing day by day, and are gaining excellent effects in training hunting dogs or pets.

Meanwhile, when a user trains an animal using the animal training system, it is general that the user holds the hand-held animal training transmitter in one hand, and manipulates, for example, presses buttons for delivering stimulation to the animal using the other hand's fingers. However, when the user holds the animal training transmitter in one hand and something (for example, a handgun for hunting) in the other hand or the user has impaired finger(s) or arm, the user has difficulty in using the general animal training system such as the above.

In this circumstance, Patent Literature 1 (US 2013/0239904) proposes an animal training transmitter including a transmitter body mounted around the back of the hand, and a control element that has only some buttons and is worn on a finger. When the user presses the button on the control element, the control element is configured to transmit a stimulation delivery signal corresponding to the button pressed by the user to a collar type animal training receiver worn on the animal through communication with the transmitter body by a wireless communication method such as Bluetooth. However, because the control element disclosed by Patent Literature 1 communicates with the transmitter body by a wireless communication method, in a situation requiring urgent stimulation delivery to the animal, stimulation may not be delivered to the animal due to communication disconnect. Furthermore, the control element disclosed by Patent Literature 1 should be separated from the transmitter body and worn on a finger. Accordingly, there is a risk of the control element getting dropped from the finger and being lost.

### SUMMARY OF THE INVENTION

The present disclosure is directed to providing a hand wearable control apparatus that transmits a remote control signal to a device positioned at a remote place without communication disconnect even in the situation where one hand is busy or has limited motion, and can be worn on a hand with no risk of being lost.

A control apparatus worn on a hand to wirelessly control a device positioned at a remote place according to an embodiment includes a finger holding portion having a hole through which a finger passes, and at least one button mounted in a region of the two side surfaces of the hole at which the finger touches, a back of hand mount portion which extends from the finger holding portion, and is worn on the back of a user's hand, the back of hand mount portion in which an electronic device electrically connected to the at least one button is mounted, and a wrist wrap portion which extends from the back of hand mount portion, and fixes around the user's wrist.

The finger holding portion according to an embodiment may have buttons mounted symmetrically on two side surfaces of the hole.

The finger holding portion according to an embodiment may have a curved end.

The finger holding portion according to an embodiment may have a button mounted such that the button is pressed down from upper and lower surfaces, and the back of hand mount portion may include a receiving part which penetrates upper and lower surfaces, and allows the electronic device to attach and detach.

The electronic device according to an embodiment may have a first terminal portion which protrudes from an outer circumferential surface, and a second terminal portion may be formed on an inner circumferential surface of the receiving part in a matching shape with the first terminal portion.

The second terminal portion according to an embodiment may be electrically connected to the button of the finger holding portion.

The at least one button of the finger holding portion according to an embodiment may be connected to a cable which extends and protrudes from the back of hand mount portion, and may be selectively attached to and detached from the finger holding portion.

The electronic device according to an embodiment may be an animal training transmitter communicates with an animal training receiver by wireless communication, the animal training receiver being worn on an animal to deliver stimulation to the animal.

The control apparatus according to an embodiment has no risk of being lost because it can be worn on a hand, and transmits a control signal to a device positioned at a remote place when a button is pressed with a finger of the hand wearing the control apparatus, thereby controlling the device positioned at a remote place in a situation where one hand is busy or has limited motion.

The control apparatus according to an embodiment is worn on any hand no matter whether the hand is right or left, and can easily control a device positioned at a remote place.

Particularly, the control apparatus according to an embodiment is applied to an animal training system to immediately respond to a situation requiring quick delivery of stimulation to an animal.

### BRIEF DESCRIPTION OF DRAWINGS

FIG. 1 is a perspective view showing a hand wearable control apparatus according to an embodiment of the present disclosure.

FIG. 2 is a diagram showing the control apparatus of FIG. 1 worn on a user's hand.

FIG. 3 is a perspective view showing a hand wearable control apparatus according to another embodiment of the present disclosure.

FIG. 4 is a perspective view showing a hand wearable control apparatus according to still another embodiment of the present disclosure.

FIG. 5 is a perspective view showing a hand wearable control apparatus according to yet another embodiment of the present disclosure.

FIG. 6 is a perspective view showing a hand wearable control apparatus according to further another embodiment of the present disclosure.

FIG. 7 is a diagram showing an animal training system according to an embodiment of the present disclosure.

FIG. 8 is a block diagram showing the configuration of an animal training transmitter of FIG. 7.

### DETAILED DESCRIPTION FOR CARRYING OUT THE INVENTION

It should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation. The description proposed herein is just a preferable example for the purpose of illustrations only, not intended to limit the scope of the disclosure, so it should be understood that other equivalents and modifications could be made thereto at the time the present application was filed.

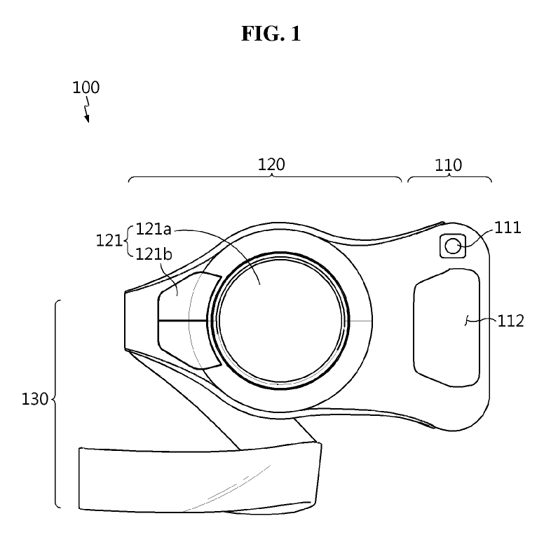

FIG. 1 is a perspective view showing a hand wearable control apparatus according to an embodiment of the present disclosure. Referring to FIG. 1, the hand wearable control apparatus 100 of this embodiment includes a finger holding portion 110, a back of hand mount portion 120 and a wrist wrap portion 130.

As shown in FIG. 1, the finger holding portion 110 has a hole 112 through which a finger, preferably, thumb, passes, and a button 111 is installed on a side surface part of two side surfaces of the hole 112 at which a finger, preferably, a thumb touches. The button 111 is electrically connected to an electronic device 121 installed in the back of hand mount portion 120 as described below. Although FIG. 1 shows that the hole 112 of the finger holding portion 110 is roughly a rectangular shape, the shape is not limited thereto and any shape allowing a finger to pass through can be used without limitation.

The back of hand mount portion 120 extends from one end of the finger holding portion 110 and is worn on the back of a user's hand. As shown in FIG. 1, the back of hand mount portion 120 has the electronic device 121 installed in the middle thereof. The electronic device 121 includes a display 121a and at least one button 121b. The display 121a may display various state information of the control apparatus 100, and the at least one button 121b is function buttons for operating the control apparatus 100. In another embodiment, when the display 121a is implemented as a touch panel, the button 121b of the back of hand mount portion 120 is not implemented as a physical button and may be implemented such that it is displayed on the display 121a and touched by the user.

The wrist wrap portion 130 extends from one end of the back of hand mount portion 120 and is fixed around the user's wrist. Because the user's finger is inserted into the hole 112 of the finger holding portion 110 and the wrist wrap portion 130 wraps the user's wrist, the control apparatus 100 may be stably fixed to the user's hand. The wrist wrap portion 130 includes fixing means so that the wrist wrap portion 130 wraps the user's wrist and is then fixed to the user's wrist. As the fixing means, Velcro, a magnet or a ring may be installed at a predetermined position of the wrist wrap portion 130.

The finger holding portion 110, the back of hand mount portion 120 and the wrist wrap portion 130 may be made of fabric materials that are soft, flexible and air permeable, such as polyamide, synthetic of polyamide and elastomer, or polyester.

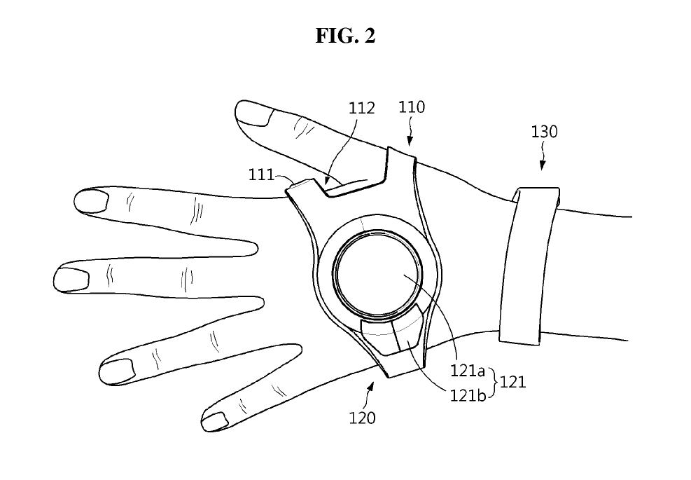

FIG. 2 is a diagram showing the control apparatus 100 of FIG. 1 worn on the user's hand. Referring to FIG. 2, the user inserts the thumb into the hole 112 of the finger holding portion 110 of the control apparatus 100 and mounts the back of hand mount portion 120 on the back of the hand. Furthermore, the user fixes the wrist wrap portion 130 around the wrist. When the control apparatus 100 is worn on the hand as described above, the button 111 electrically connected to the body of the control apparatus 100 is disposed at the position where the user bends the thumb, and when the user needs to transmit a control signal to a device positioned at a remote place, the user transmits a control signal by pressing the button 111. Thus, the user can perform user inputs to the control apparatus 100 even when the user does not hold the control apparatus 100 in the hand.

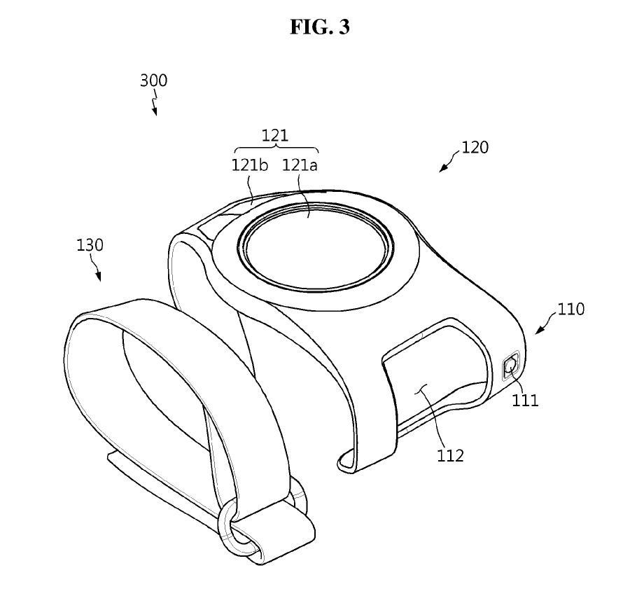

FIG. 3 is a perspective view showing a hand wearable control apparatus according to another embodiment of the present disclosure. The basic configuration of the control apparatus 300 shown in FIG. 3 is the same as that of the control apparatus 100 shown in FIG. 1. However, the finger holding portion 110 and the back of hand mount portion 120 of the control apparatus 300 shown in FIG. 3 is made of rubber or plastic dissimilar to the control apparatus 100 shown in FIG. 1, and the end of the finger holding portion 110 is curved in the thickness-wise direction of the hand. Accordingly, when the finger is inserted into the finger holding portion 110, it can be more stably fixed, and the pressure applied to the finger is reduced. Furthermore, a part of the back of hand mount portion 120 connected to the wrist wrap portion 130 is also curved in the thickness-wise direction of the hand. Accordingly, the back of hand mount portion 120 is stably worn on the back of the hand.

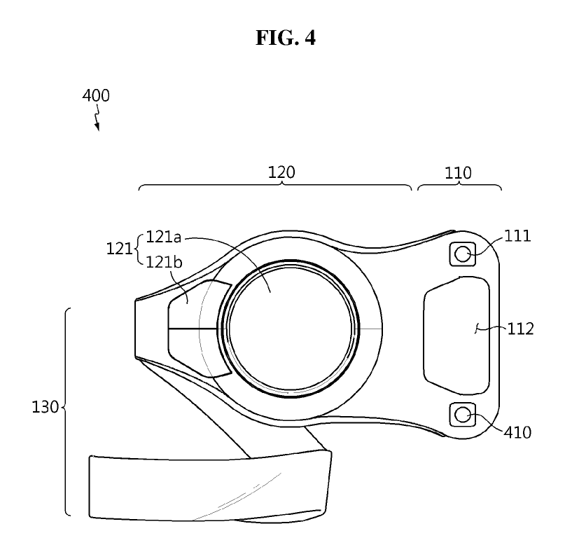

FIG. 4 is a perspective view showing a hand wearable control apparatus according to still another embodiment of the present disclosure. In FIG. 4, the elements of the same reference numerals as FIG. 1 include the structure and function described with reference to FIG. 1. The control apparatus 400 shown in FIG. 4 has two buttons 111, 410 symmetrically installed in the finger holding portion 110, compared to the control apparatus 100 shown in FIG. 1. That is, the two buttons 111, 410 are symmetrically disposed on two sides of the finger holding portion 100 with regard to the hole 112. The control apparatus 100 of the embodiment described with reference to FIG. 1 can be only worn on the user's left hand, but the control apparatus 400 of the embodiment described with reference to FIG. 4 can be worn on two hands due to the two buttons 111, 410 symmetrically installed in the finger holding portion 110. The finger holding portion 110 and the back of hand mount portion 120 of the control apparatus 400 shown in FIG. 4 may be made of rubber or plastic as described with reference to FIG. 2.

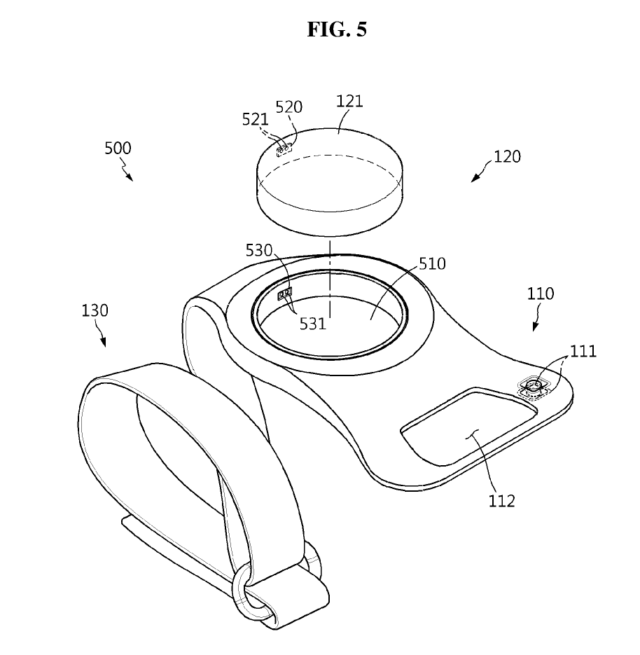

FIG. 5 is a perspective view showing a hand wearable control apparatus according to yet another embodiment of the present disclosure. In FIG. 5 the elements of the same reference numerals as FIG. 1 include the structure and function described with reference to FIG. 1. The finger holding portion 110 of the control apparatus 500 shown in FIG. 5 is the same as the finger holding portion 110 of the control apparatus 100 shown in FIG. 1. However, the button 111 installed in the finger holding portion 110 of the control apparatus 500 shown in FIG. 5 is formed through upper and lower surfaces, and is installed with a structure in which the button 111 is pressed down from the upper surface or the lower surface.

Furthermore, as shown in FIG. 5, the electronic device 121 included in the back of hand mount portion 120 of the control apparatus 500 may be attached to and detached from the back of hand mount portion 120. Accordingly, the back of hand mount portion 120 includes a receiving part 510 in the shape of a hole in which the electronic device 121 is received. The receiving part 510 is a hole that penetrates the upper surface and the lower surface. In this embodiment, the back of hand mount portion 120 is made of a material having elasticity such as rubber, and preferably, the diameter of the receiving part 510 is smaller than the diameter of the electronic device 121 so that the electronic device 121 is mounted and fixed in the receiving part 510.

The electronic device 121 includes a first terminal portion 520 on the outer circumferential surface. The first terminal portion 520 protrudes from the outer circumferential surface of the electronic device 121, and includes a pair of terminals 521. Furthermore, the inner circumferential surface of the receiving part 510 of the back of hand mount portion 120 includes a second terminal portion 530 in a complementary shape to the first terminal portion 520. The second terminal portion 530 includes a pair of terminals 531 for contacting the pair of terminals 521 of the first terminal portion 520. The pair of terminals 531 of the second terminal portion 530 is electrically connected to the button 111 of the finger holding portion 110, and when a flexible battery is embedded in the back of hand mount portion 120, they may be also electrically connected to the flexible battery. Furthermore, although not shown in FIG. 5, when the button 121b is installed in the back of hand mount portion 120 as shown in FIG. 1, the pair of terminals 531 of the second terminal portion 530 of the receiving part 510 may be also electrically connected to the button 121b. Although this embodiment describes that there are two terminals 521, 531 for each terminal portion 520, 530, the number of terminal may increase or decrease depending on a target to electrically connect.

Because the control apparatus 500 of the embodiment described with reference to FIG. 5 has the electronic device 121 that can be attached and detached and the receiving part 510 in the shape of a hole, the electronic device 121 may be mounted on the upper or lower surface of the back of hand mount portion 120 in any direction. Accordingly, with only one button 111 installed in the finger holding portion 110, the control apparatus 500 may be used in both the right hand and the left hand. In the embodiment described with reference to FIG. 5, the back of hand mount portion 120 is made of a material having elasticity to fix the electronic device 121, but is not limited thereto and may fix the electronic device 121 using a ball screw structure, or may fix the electronic device 121 using a step structure. Alternatively, receptacle may be installed in the receiving part 510 to attach and detach the electronic device 121.

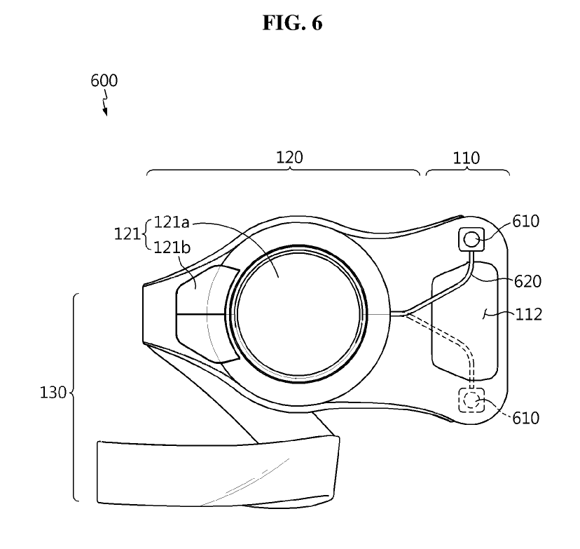

FIG. 6 is a perspective view showing a hand wearable control apparatus according to further another embodiment of the present disclosure. In the control apparatus 600 of the embodiment described with reference to FIG. 6, the same elements as the reference numerals of FIG. 1 are the same as the elements described with reference to FIG. 1. In the control apparatus 100 shown in FIG. 1, the button 111 is mechanically fixed and installed in the finger holding portion 110. However, in the control apparatus 600 of this embodiment described with reference to FIG. 6, a button is not mechanically fixed and installed in the finger holding portion 110, a cable 620 protrudes and extends from the back of hand mount portion 120, and a button 610 is connected to the end of the protruding cable 620. The cable 620 is electrically connected to the electronic device 121 of the back of hand mount portion 120. Accordingly, the user wears the control apparatus 600 in the right hand or the left hand, and then attaches the button 610 to the position at which the thumb touches in the finger holding portion 110. The finger holding portion 110 and the button 610 may be attached and detached through attaching/detaching means such as a magnet or Velcro.

Hereinafter, examples of application of the control apparatus 100, 300, 400, 500, 600 described with reference to FIGS. 1 to 6 are described. The control apparatus 100, 300, 400, 500, 600 may be applied to an animal training system.

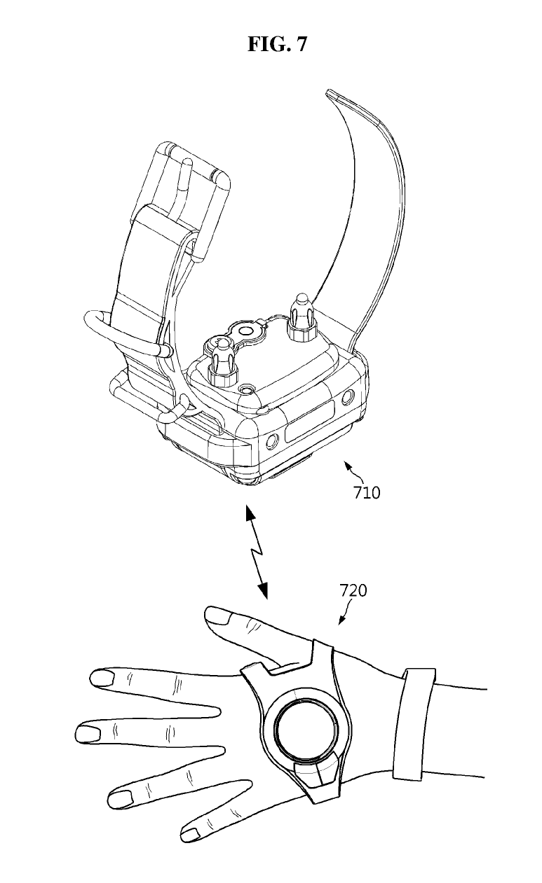

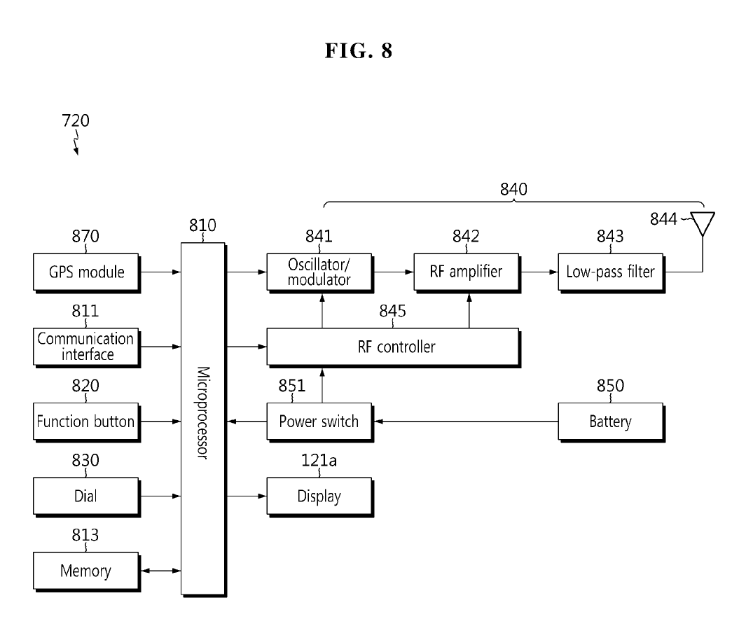

FIG. 7 is a diagram showing an animal training system according to an embodiment of the present disclosure, and FIG. 8 is a block diagram showing the configuration of the animal training transmitter of FIG. 7.

As shown in FIG. 7, the animal training system includes an animal training receiver 710 worn on an animal to deliver stimulation for behavior modification to the animal when the animal does a behavior needed to correct, and an animal training transmitter 720 possessed by a user to control the animal training receiver 710. The animal training receiver 710 is configured to communicate with the animal training transmitter 720 via wireless communication, and operates under the control of the animal training transmitter 720. The control apparatus 100, 300, 400, 500, 600 may be used as the animal training transmitter 720.

The animal training receiver 710 of this embodiment shown in FIG. 7 is a common electronic animal training receiver used to train the animal (the present disclosure is not limited thereto, but typically, a dog) or correct behaviors, and is typically worn around the neck of the animal. Accordingly, the animal training receiver 710 includes elements used for common animal training receivers, such as a stimulation generation/delivery module, a microprocessor, a wireless communication module, a battery and a necessary sensor. The stimulation generation/delivery module includes stimulation means and its driver employed by common electronic animal training receivers, and the stimulation typically includes electrical stimulation, sound stimulation, vibration stimulation, and the like.

Referring to FIG. 8, the animal training transmitter 720 includes user input means to select a stimulation mode including the type, duration and/or intensity of stimulation to be delivered by the animal training receiver 710 or select functions provided by the animal training system and input an execution command, a wireless communication module 840 to transmit signals representing the stimulation mode or function selected by the user input means to the animal training receiver 710, a microprocessor 810 to process the signals and control the wireless communication module 840, a battery 850, and a power switch 851.

The user input means includes at least one button 820 or a switch and a dial 830 to allow the user to set the type, intensity, and duration of stimulation to deliver to the animal through the animal training receiver 710. The dial 830 is a switch which adjusts the intensity or frequency of currently selected stimulation (electrical stimulation, sound stimulation, vibration stimulation, etc.). The type, duration, intensity and frequency of stimulation may be adjusted by a combination of one button 820 and the dial 830, or by the use of a plurality of buttons 820, the type of stimulation may be selected and an execution command may be inputted, or initialization, registration or setting change of the animal training transmitter 720 or the animal training receiver 710 may be carried out. The button 810 and the power switch 851 may correspond to the button 121b installed in the back of hand mount portion 120 of the control apparatus 100 described with reference to FIG. 1. Furthermore, the button 810 includes the button 111 installed in the finger holding portion 110, the button 121b of the back of hand mount portion 120, and the button 610 extending and protruding from the back of hand mount portion 120 described with reference to FIGS. 1 to 6.

Furthermore, when the user selects a particular stimulation mode to be delivered by the animal training receiver 710 or a particular function provided by the animal training system and commands with a voice, the user input means may include a microphone that inputs the voice. The user input means, i.e., the function button 820, the dial 830 and the power switch 851 may be placed near the display 121a. In another embodiment, when the display 121a is implemented as a touch panel, the function button 820 or the dial 830 is not implemented as a physical button and may be implemented such that it is displayed on the display 121a and touched by the user.

The wireless communication module 840 includes an oscillator/modulator 841, a radio frequency (RF) amplifier 842, a low-pass filter 843, an antenna 844, and an RF controller 845. The oscillator/modulator 841 modulates a signal inputted from the microprocessor 810 based on a wireless communication method, and the RF amplifier 842 amplifies the RF signal from the oscillator/modulator 851. The low-pass filter 843 blocks harmonics other than the fundamental waves in the amplified RF signal, and the antenna 844 transmits the RF signal composed of the fundamental waves having passed through the low-pass filter. Furthermore, when a control signal needs to be transmitted to the animal training receiver 710 in response to an input from the user through the user input means of the animal training transmitter 720, the RF controller 845 supplies power to operate the oscillator/modulator 841 and the RF amplifier 842.

The battery 850 supplies required power to each component of the animal training transmitter 720, especially the microprocessor 810 and the wireless communication module 840, etc., and preferably includes a rechargeable secondary battery.

The power switch 851 is a switch which switches on/off of the animal training transmitter 720. The animal training transmitter 720 may be equipped with a regulator (not shown) connected to the power switch 851 to uniformly maintain the voltage of power supplied from the battery 850.

Furthermore, the animal training transmitter 720 of this embodiment may further include the display 121a. The display 121a may display the type, intensity, and frequency of stimulation selected/set by the user input means or the settings of the animal training transmitter 720 or the animal training receiver 710 and further, the remaining amount of the battery 850 of the animal training transmitter 720.

Although not essential, the animal training transmitter 720 of this embodiment may include a GPS module 870. The GPS module 870 receives a signal from a satellite and displays location information of the user, i.e., the animal training transmitter 720 on the display 121a.

The microprocessor 810 controls the entire operation of the animal training system including the animal training receiver 710 and the animal training transmitter 720. The microprocessor 810 is typically implemented as an IC chip, and may have a necessary memory 813 or register, and the operation of the microprocessor 810 may be implemented as control logic programmed in software, firmware and hardwired logic.

The memory 813 stores programs that define the operation of the microprocessor 810 or data of the set conditions. Furthermore, each time the animal training receiver 710 is commanded to work through the animal training transmitter 720, the memory 813 may store a working history including the working time and the intensity of stimulation at that time. The user sees the stored working history through an external terminal such as a computer terminal or a smart phone, and thus the user can monitor when and how often the corresponding animal did behaviors needed to correct, if suitable behavior modification is being implemented, and if the stimulation mode such as the intensity of stimulation being currently set is proper.

The communication interface 811 electrically connects the microprocessor 810 and an external terminal. The communication interface 811 may include a USB port and a USB communication cable. The communication interface 811 may be implemented by a wired method as well as a wireless communication method such as Bluetooth. The communication interface including the USB port and the USB communication cable may be also used to charge the battery 850.

While the present disclosure has been described with regard to the embodiments, various modifications and changes may be made thereto by person having ordinary skill in the technical field to which the present disclosure belongs without departing from the technical aspects of the present disclosure. Therefore, the present disclosure should not be limited to the narrower scope than the scope of the appended claims.

What is claimed is:

1. A control apparatus worn on a hand to wirelessly control a device positioned at a remote place, the control apparatus comprising:
a finger holding portion having a hole through which a finger passes, and at least one button mounted in a region of the two side surfaces of the hole at which the finger touches;
a back of hand mount portion which extends from the finger holding portion, and is worn on the back of a user's hand, the back of hand mount portion in which an electronic device electrically connected to the at least one button is mounted; and
a wrist wrap portion which extends from the back of hand mount portion, and fixes around the user's wrist.

2. The control apparatus according to claim 1, wherein the finger holding portion has buttons mounted symmetrically on two side surfaces of the hole.

3. The control apparatus according to claim 1, wherein the finger holding portion has a curved end.

4. The control apparatus according to claim 1, wherein the finger holding portion has a button mounted such that the button is pressed down from upper and lower surfaces, and
the back of hand mount portion includes a receiving part which penetrates upper and lower surfaces, and allows the electronic device to attach and detach.

5. The control apparatus according to claim 4, wherein the electronic device has a first terminal portion which protrudes from an outer circumferential surface, and
a second terminal portion is formed on an inner circumferential surface of the receiving part in a matching shape with the first terminal portion.

6. The control apparatus according to claim 5, wherein the second terminal portion is electrically connected to the button of the finger holding portion.

7. The control apparatus according to claim 1, wherein the at least one button of the finger holding portion is connected to a cable which extends and protrudes from the back of hand mount portion, and is selectively attached to and detached from the finger holding portion

8. The control apparatus according to claim 1, wherein the electronic device is an animal training transmitter communicates with an animal training receiver by wireless communication, the animal training receiver being worn on an animal to deliver stimulation to the animal.
